(19) United States
(12) Patent Application Publication
(10) Pub. No.: US 2024/0144559 A1
(43) Pub. Date: May 2, 2024

(54) SYSTEM AND METHOD FOR GENERATING AND RENDERING A SELF-CONTAINED REPORT DATA STRUCTURE

(71) Applicant: Digits Financial, Inc., San Francisco, CA (US)

(72) Inventors: Manuel Deschamps Rascon, Green Cove Springs, FL (US); Stephen Mark Panaro, Melrose, MA (US); Ryan Lawrence Holcombe, Thornton, CO (US); Sanjeet Das, New York, NY (US); Michael Furtak, Malden, MA (US); Mark Eli Moreau Roseboom, Portland, ME (US); Jeffrey Hall Seibert, Jr., Hillsborough, CA (US)

(21) Appl. No.: 18/409,941

(22) Filed: Jan. 11, 2024

Related U.S. Application Data
(63) Continuation-in-part of application No. 18/236,129, filed on Aug. 21, 2023.
Application No. 18/236,129 is a continuation of application No. 17/070,248, filed on Oct. 14, 2020, now Pat. No. 11,769,282.

(51) Int. Cl. G06T 11/20; G06F 16/248; G06F 40/18

(52) U.S. Cl. CPC G06T 11/206; G06F 16/248; G06F 40/18

(57) ABSTRACT

A system and method for automatically generating and rendering a report data structure is provided. The report data structure is formed in a platform independent manner that includes all data for transactions used in the report. The system analyzes the transactions to be included in the report and selects the type of display component based on a ranking score to best highlight the data contained therein.

### CROSS-REFERENCE TO RELATED APPLICATIONS

The present application is a continuation in part of commonly assigned copending U.S. patent application Ser. No. 18/236,129, which was filed on Aug. 21, 2023, by Manuel Deschamps Rascon et al., for a SYSTEM AND METHOD FOR GENERATING AND RENDERING A SELF-CONTAINED REPORT DATA STRUCTURE, which claims priority to commonly assigned U.S. Pat. No. 11,769,282, which issued on to Sep. 26, 2023, to Manuel Deschamps Rascon et al., for a SYSTEM AND METHOD FOR GENERATING AND RENDERING A SELF-CONTAINED REPORT DATA STRUCTURE, both of which are hereby incorporated by reference.

### BACKGROUND

### Technical Field

The present invention is directed towards reports and, more particularly towards automatically generating and rendering a report.

### Background Information

Numerous systems generate reports for review including, for example, financial and accounting systems, engineering systems, monitoring and control systems, etc. The report may be selected from a predefined template set by the system or a user may manually select one or more items to be included in the report. The system generates the report and typically displays the report and/or outputs the report in a document that may be printed or otherwise distributed.

In certain systems, the report document may be editable and may contain data that may be further manipulated. For example, a financial report may be generated as a spreadsheet that, depending on user permissions, may be further edited. In other systems, the report may be generated into a fixed format, such as the Portable Document Format (PDF) for printing or distribution. Other reports may comprise text documents, word processing system documents, etc.

One notable disadvantage of conventional report generation systems is that they are limited to predefined templates provided by the system provider. Certain systems may enable a user to provide some customization by determining what elements are to be included and in what order they are to be presented. When the user desires to generate a report for a given time, the system will gather the data and populate the report using the predefined template. A noted disadvantage of such statically formatted reports may arise when, for example, a significant change occurs in one or more entries, but the report type or format is not configured to highlight such changes. For example, if a metric has had a significant change, for better or worse, but the component of the report that includes that metric had not been selected by the user, not included in the system's template, and/or located in the report in a non-highlighted location, a reader of the report may miss the important data.

A further noted disadvantage is that the user selected components may not be applicable for certain data values. For example, assume that a user has selected to display monthly spending using a pie chart. If a refund occurs in a particular month, the spending in that category may be negative, reflecting the refund. A pie chart cannot appropriately display the fact that there is a negative value associated with one of the entries. This predefined report would be rendered useless by the actual data encountered. As will be appreciated by those skilled in the art, other types of mismatches may occur between the desire to represent data in a meaningful way and the actual data values.

A further noted disadvantage is that the report document typically does not contain all the transactions that were utilized to generate the report. Instead, the report document includes summations of the transactions. Therefore, even an interactive report may be limited to the extent of data that may be displayed.

### SUMMARY

The disadvantages of the prior art are overcome by providing a system and method for generation and rendering of reports stored within a self-contained data structure. Advantageously, the self-contained data structure includes all the data necessary to render the report across a plurality of differing platforms. Reports may be generated automatically based on predefined criteria, on a predefined schedule, or in response to user input. A type of report and time period are first selected. Then, a snapshot of the data set that is applicable to the type of report and time period is obtained. Illustratively, in a financial/accounting report, this data set may comprise a set of all transactions, or other entries, that are needed for the report.

Based on the type of report, one or more report sections are identified. Within each section, one or more components are determined based on the data set. As used herein, a component comprises a textual or graphical representation of information related to the data set. Examples of components include, bar charts, scatter plots, line graphs, etc. A report generator analyzes the data set to identify which components best display the data and selects that component to display the particular data. Once the components have been selected, they are ranked. Sections are then ranked using the rankings of the components contained therein.

The report is then generated using the ranked sections and is stored in an exemplary data structure along with the data set used. The report data structure is illustratively a hierarchical structure that may be rendered on differing platforms. When a report is to be rendered, a report renderer can read the report data structure, identify the sections and components to be rendered, and render them using the data contained within the report data structure. By storing the report in a platform independent data structure, a report renderer may display the report in a manner most suitable to the device on which it is running, e.g., desktop computer, tablet, smart phone, etc. Further, by storing the entries used to generate the components in the data structure, a report renderer may cause certain components to be interactive, e.g., display underlying transactions when an aggregate value is highlighted or selected.

### BRIEF DESCRIPTION OF THE DRAWINGS

The above and further advantages of the present invention may be better understood in relation to the accompanying figures, in which like reference numerals indicate identical or substantially identical elements, of which:

FIG. 1 is a schematic block diagram of an exemplary network environment in accordance with an illustrative embodiment of the present invention;

FIG. 2 is a schematic block diagram of an exemplary server system in accordance with an illustrative embodiment of the present invention;

FIG. 3 is a schematic block diagram of an exemplary client computer system in accordance with an illustrative embodiment of the present invention;

FIG. 4 is a schematic block diagram of an exemplary mobile device in accordance with an illustrative embodiment of the present invention;

FIG. 5A is an exemplary data structure of a report wrapper data structure in accordance with an illustrative embodiment of the present invention;

FIG. 5B is an exemplary report data structure in accordance with an illustrative embodiment of the present invention;

FIG. 6A is an image of a first page of an exemplary report in accordance with an illustrative embodiment of the present invention;

FIG. 6B is an image of a second page of an exemplary report in accordance with an illustrative embodiment of the present invention;

FIG. 6C is an image of a third page of an exemplary report in accordance with an is illustrative embodiment of the present invention;

FIG. 6D is an image of a fourth page of an exemplary report in accordance with an illustrative embodiment of the present invention;

FIG. 6E is an image of a fifth page of an exemplary report in accordance with an illustrative embodiment of the present invention;

FIG. 7 is a flowchart detailing the steps of a procedure for automatically generating a report in accordance with an illustrative embodiment of the present invention;

FIG. 8 is a flowchart detailing the steps of a procedure for rendering a report in accordance with an illustrative embodiment of the present invention;

FIG. 9 is a flowchart detailing the steps of a procedure for automatically generating a report using artificial intelligence in accordance with an illustrative embodiment of the present invention; and

FIG. 10 is a flowchart detailing the steps of a procedure for automatically generating a report based on user manipulation within a user interface in accordance with an illustrative embodiment of the present invention.

### DETAILED DESCRIPTION OF AN ILLUSTRATIVE EMBODIMENT

### I. Network Environment and Systems

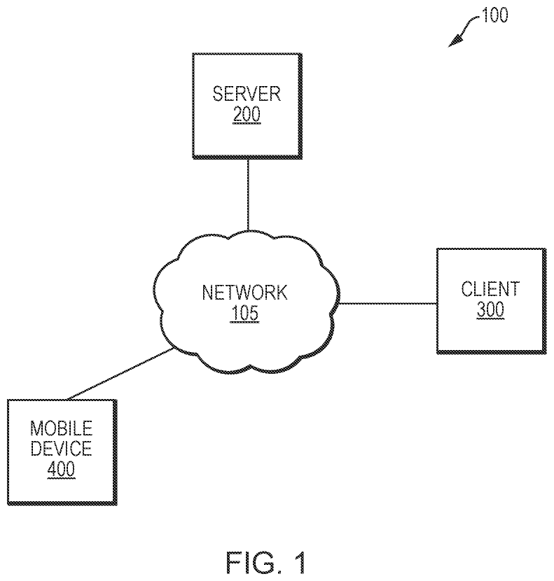

FIG. 1 is a schematic block diagram of an exemplary computer network environment 100 in accordance with an illustrative embodiment of the present invention. Specifically, the network environment 100 comprises of a network 105 that is operatively interconnected with one or more servers 200, clients 300, and/or mobile devices 400. It should be noted that network 105 is illustratively shown as a single network entity. However, it is expressly contemplated that network 105 may comprise of a plurality of interconnecting networks of the same and/or differing types, including, e.g., Wi-Fi networks, cellular telephone networks, local area networks (LANs), and/or wide area networks (WANs) including, for example, the well-known Internet. The various network connected entities typically communicate over the network 105 by exchanging discrete frames or packets of data according to predefined protocols, such as a Transmission Control Protocol/Internet Protocol (TCP/IP), Hypertext Transfer Protocol (HTTP), etc. Thus, for example, in an illustrative embodiment, a mobile device 400 may communicate using a cellular telephone network to transmit data. The exemplary cellular telephone network may then be interconnected with the Internet, which is further connected to a LAN, which ultimately is operatively connected to server 200.

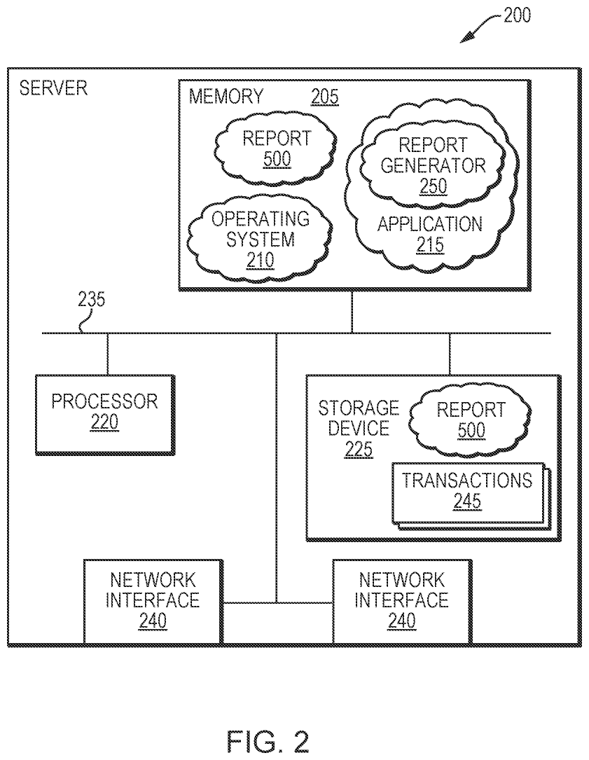

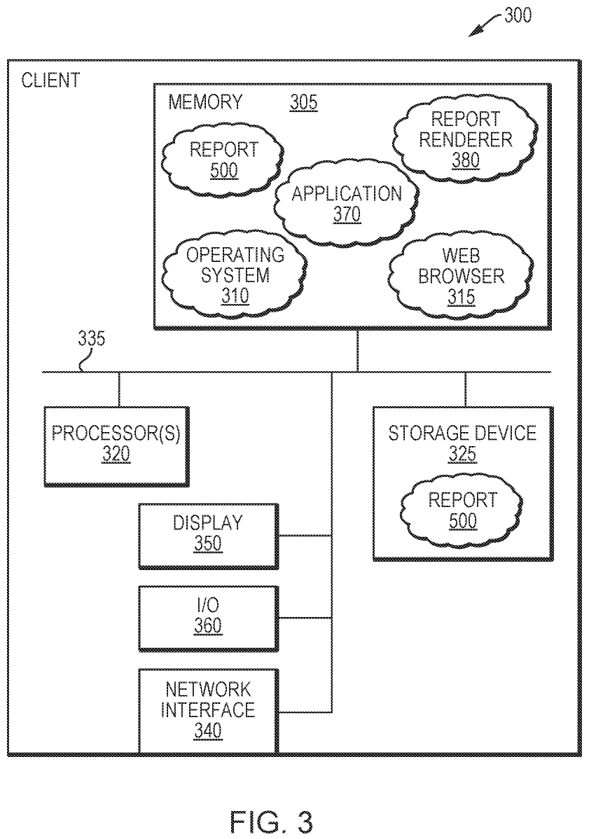

Exemplary servers 200, described below in reference to FIG. 2, may execute an application that produces a report data structure that may be rendered on a client 300 or mobile device 400. Client computer 300, described further below in reference to FIG. 3, may comprise a user's computer that executes software designed to render the report data structure in accordance with an illustrative embodiment of the present invention. In alternative embodiments of the present invention, client computer 300 may communicate in a client-server relationship with server 200 to access an application executing on the server. In other alternative embodiments of the present invention, client computer 300 may execute a web browser that accesses server 200 to display information, including a report, relating to an application.

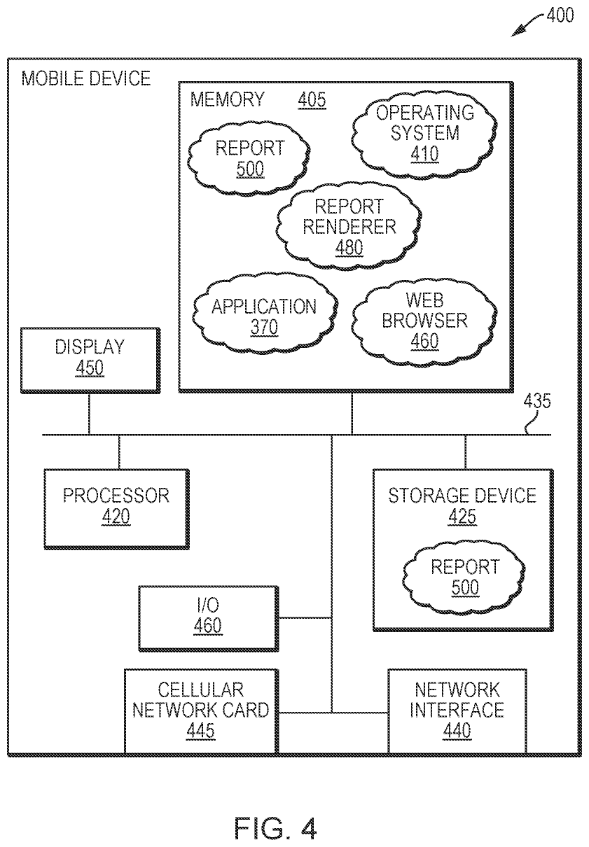

Mobile device 400, described further below in reference to FIG. 4, is also illustratively operatively connected to network 105. Illustratively, mobile device 400 may comprise a smart phone, a personal digital assistant and/or a tablet computer. More generally, mobile device 400 may comprise any movable device capable of executing applications and/or accessing the worldwide web (WWW) via, e.g., a web browser.

Further, it should be noted that while a single server 200, client 300, and mobile device 400 are described and illustrated, in alternative embodiments of the present invention, a plurality of such network entities may be utilized. Therefore, the description and illustration of a single server 200, client 300, and/or mobile device 400 should be taken as exemplary only.

FIG. 2 is a schematic block diagram of an exemplary server 200 in accordance with an illustrative embodiment of the present invention. The server 200 may illustratively comprise of one or more network interfaces 240, one or more processors 220, one or more storage devices 225, and a memory 205 operatively interconnected by a system bus 235.

The network interface 240 illustratively contains the mechanical, electrical, and signaling circuitry for communicating data over physical links coupled to a network. The network interface may be configured to transmit and/or receive data using a variety of different communication protocols, including, inter alia, TCP/IP, UDP, ATM, SONET, HTTP, wireless protocols, Frame Relay, Ethernet, Fiber Distributed Data Interface (FDDI), etc. Notably, a physical network interface 240 may also be used to implement one or more virtual network interfaces, such as for Virtual Private Network (VPN) access, as is known to those skilled in the art.

The memory 205 comprises a plurality of locations that are addressable by the processor(s) 220 and the network interface 240 for storing software programs and data structures associated with the various embodiments described herein. The processor 220 may comprise necessary elements or logic adapted to execute software programs and manipulate data structures. An operating system 210, portions of which are typically resident in memory 205 and executed by the processor(s), functionally organizes the server 200 by, inter alia, invoking network operations in support of software processes and/or services executing on the server. An application 215, portions of which may be resident in memory 205, is executed by the processor to implement various functionality, such as an engineering monitoring system, a financial accounting system, etc. The descriptions and illustrations contained herein are directed towards an exemplary application 215 that implements a financial accounting system. However, it should be noted that it is expressly contemplated that the application 215 may implement other types of systems. Therefore, the description of a financial accounting system application 215 should be taken as exemplary only.

In accordance with an illustrative embodiment of the present invention, the application includes a report generator 250 module. It should be noted that in environment 200, report generator 250 is shown as being part of application 215, in alternative embodiments, the report generator 250 may be a separate program. More generally, the report generator 250 may be standalone software or its functionality may be incorporated into other software. Therefore, the description of report generator being part of application 215 should be taken as exemplary only.

In accordance with exemplary embodiments of the present invention, the report generator 250 is configured to generate reports, as described further below. These reports may be automatically generated in response to, e.g., a preconfigured schedule, a user instructing the system to generate a report, a value exceeding a predefined threshold, etc. One example would be that the application may be configured to generate a monthly spending report detailing the spend of the previous month on the first business day of the next month. Another example would be a user initiating a report generation as the user needs the report for a business purpose, e.g., a board of directors meeting.

In an embodiment, a report is a frozen or static version of a dashboard that is considered “live”. For example, a dashboard may continuously receive and display real-time or near real-time data, whereas a report may represent a frozen snapshot of the dashboard at one or more particular times. As will be described in further detail below, a dashboard may be utilized internally by an entity, while a report may be shared with one or more users that are external to the entity. According to the one or more embodiments as described herein, a dashboard may be referred to as a live report.

In response, the report generator 250 analyzes the various transaction data entries 245 and generates a report data structure 500. The report data structure may be stored in memory 205 or on storage device 225. Further, the report data structure 500 may be transmitted over network interface 240 to computer 300 and/or mobile device 400.

It should be noted that in an illustrative embodiment of the present invention, the application 215 may be configured to operate in a client/server manner in which the application 215 executes on the server, but displays reports on a client 300 and/or mobile device 400. In alternative embodiments of the present invention, the application 215 may interact with a web server (not shown) executing on server 200 to provide reports accessible via a web browser that may be executed on, e.g., client 300 or mobile device 400.

The storage device 225, which may be internal or external to the server 200, stores data associated with the operating system 210 and application 215. In alternative embodiments, storage device 225 may comprise a plurality of devices, which may be internal and/or external to server 200. Storage device 225 may comprise a cloud-based storage, RAID array, etc. in accordance with alternative embodiments of the present invention. In accordance with an illustrative embodiment of the present invention, the storage device 225 stores transaction data 245 associated with the application 215. The present invention is written in terms of an application for accounting/finance. As such, the data associated with the application 215 comprises transaction data 245, e.g., records for each financial transaction. In alternative embodiments, the transaction data 245 may comprise the individual data entries that are utilized to generate the report data structure 500. For example, in a monitoring and control application 215, the transaction data 245 may represent readings taken from monitors at time intervals, e.g., the pressure measured at a gauge at time X, X+1, etc. Therefore, while the data is described as transaction data, it is expressly contemplated that the data 245 used to generate report data structure 500 may comprise other types of data. Further, the storage device 225 may store report data structure 500.

In alternative embodiments of the present invention, the various functionalities may be distributed among a plurality of servers. As such, the description of a single server 200 should be taken as exemplary only. Also, while the embodiments herein are described in terms of processes or services implemented as software executing on a processor, alternative embodiments may include the processes described herein being embodied as modules consisting of hardware, software, firmware, and/or combinations thereof. Therefore, the description of software applications should be taken as exemplary only.

FIG. 3 is a schematic block diagram of an exemplary client computer system 300 in accordance with an illustrative embodiment of the present invention. The client computer system 300, illustratively comprises a memory 305, one or more processors 320, one or more storage devices 325, a network interface 340, a display 350, and one or more forms of input/output (I/O) 360 that all operatively interconnected by a system bus 335. Memory 305, processors 320, storage device 325, and network interface 340 illustratively perform similar functions as described above in relation to server 200.

The display 350 may illustratively comprise a conventional liquid crystal display (LCD) or light emitting diode (LED) computer monitor or other visual display as are known to those skilled in the art. The I/O system 360 may comprise, for example, a keyboard, mouse, light pen, touchscreen and/or other forms of inputting data and manipulating GUI elements in accordance with various embodiments of the present invention. In one illustrative embodiment, the I/O may comprise a keyboard and mouse that may be utilized to enter data and to rearrange a plurality of GUI windows.

A web browser 315 enables a user of the client computer system 300 to access a webpage provided by application 215. Illustratively, the web browser 315 accesses a webpage provided by application 215 via web server (not shown) executing on server 200. In alternative embodiments, a local version of the application 370 may be stored in memory 305 and executed by processor 320.

Memory also includes a report renderer module 350 that will render a report data structure 500 for display on a screen or to be printed on a printer (not shown). Illustratively, the report renderer 350 is shown as a separate module. However, in accordance with alternative embodiments of the present invention, the report renderer 350 may be integrated into the web browser 315, application, and/or operating system 310. Therefore, the description of report renderer 350 being a separate module should be taken as exemplary only. In operation, the report renderer 250 examines the report data structure 500 and renders the report contained therein in a manner suitable for display on the I/O devices associated with system 300.

FIG. 4 is a schematic block diagram of an exemplary mobile device 400 in accordance with an illustrative embodiment of the present invention. As noted above, mobile device 400 may comprise any device capable of executing applications and/or accessing the World Wide Web. Illustratively, mobile device 400 may comprise a smart phone, a personal digital assistant (PDA), and/or a tablet computer. The mobile device 400 illustratively comprises network interfaces 440, one or more processors 420, a memory 405, a storage device 425, and a cellular network card 445 interconnected by a system bus 435.

Memory 405, processor 420, storage device, I/O 460, and network interface 440 function similarly to those components described above. Display 450 may comprise a touchscreen that is used for both display and input purposes. Cellular network card 445 may implement the circuitry to enable the mobile device to access one or more cellular networks for, e.g., data transmission and reception.

Memory 405 illustratively stores an operating system 410, an application 370, a web browser 460, a report renderer module 480, and/or a report data structure 500. The operating system 410 functionally organizes the mobile device 400 and provides a mechanism for applications to execute thereon. The web browser 460 may be used to access the world wide web, including, in alternative embodiments, application executing on server. The application 370 may nm locally on mobile device.

The report renderer module 480 may be integrated into operating system 410, application 370, and/or web browser 460 in accordance with alternative embodiments. The report renderer may also be implemented as a standalone software. Therefore, the description of report renderer 480 being a separate module should be taken as exemplary only.

### II. Self-Contained Report Data Structure

Embodiments of the present invention are directed to the generation and rendering of reports using an exemplary report data structure. While the description contained herein is directed to financial reports, the principles of the present invention may be utilized in other fields. As will be appreciated, the use of the term transactions is directed to a financial report. More generally, a transaction should be viewed as an entry of the data utilized to generate the report. As will be appreciated by those skilled in the art, the time and effort required to produce financial reports is high, especially if they are bespoke to an individual company. The present invention enables the automated generation of high-value and customized financial reports that are specific to a business. Given that each business is different, the system is capable of adjusting the portions of a report to adapt to a given business. Portions of a report are included/excluded based on the usefulness as well as sorted based on usefulness.

The principles of the present invention enable a new type of reporting experience that differs from the prior art experiences. As will be appreciated by those skilled in the art, conventional report experiences are typically divided into either a completely static report or a real-time dashboard display. Both experiences have noted disadvantages. Static reports, such as a report stored in the well-known PDF format, are generated once and remain static and non-interactive. The real-time dashboard display experience may be computationally expensive depending on complexity, which may require processing to be done on a server and then displayed on an end user's device. This requires network connectivity in the client-server model, or for the end user's device to have sufficient processing power to render the report in a manner that does not invoke lag times in rendering information. Although the examples and description may at times refer to a static report, it is expressly contemplated that the one or more embodiments as described herein are applicable to live reports, i.e., dashboards, that receive and display real-time or near real-time data. The present invention provides a new experience in that the substantially complex processing is performed at report generation time. The report is then stored in a platform independent format that may be rendered by report renderers that do not require complex processing. Instead, the report renderers simply render the report sections, and associated components, in the specified order from the report data structure. As all the data to be displayed is contained within the report data structure, rendering is substantially instantaneous. Further, as the data is available in the report data structure, components may include interactivity, such as displaying individual entries that have been aggregated for display and/or displaying particular display options, e.g., sparkline visual, with the component.

In general, an exemplary report generator will capture a data set, e.g., all transaction data, for a given time period, and analyze it to identify items that may be of interest, especially when compared to, e.g., a predefined comparison time period. The report generator will also identify (1) ideal components for display of the data that may be ranked to determine the best display and/or (2) display options (e.g., sparkline visual) for each report section that best highlights the data within the report section. Examples of decisions that may be automated include, e.g., if company spending in a time period is split between a few large categories and a plurality of smaller ones, a pie chart may be ideal, assuming that there are no negative numbers. However, if there is a negative number, e.g., representative of a refund, then a waterfall graph may be ideal. Similarly, a sparkline visual may be a display option best suited to highlight each row of a profit and loss statement.

The report is illustratively stored in an exemplary hierarchical data structure that includes top level information and then one or more sections, each of which includes one or more components and one or more display options. As used herein a section is defined as a set of components. Various sections may have a list of predefined eligible components that may be included depending on the data set. A component is generally defined as a collection of data and metadata that is needed to render the data and a display option is generally defined as a manner in which data is highlighted, accentuated, or prioritized in a report section and/or component, for example. Exemplary components include various types of charts, graphs, tables, etc. In an illustrative embodiment, the report generator and report renderer maintain a master list of component types and display options that may be utilized in various reports. When a report type is created, one or more section types may be associated with the report type.

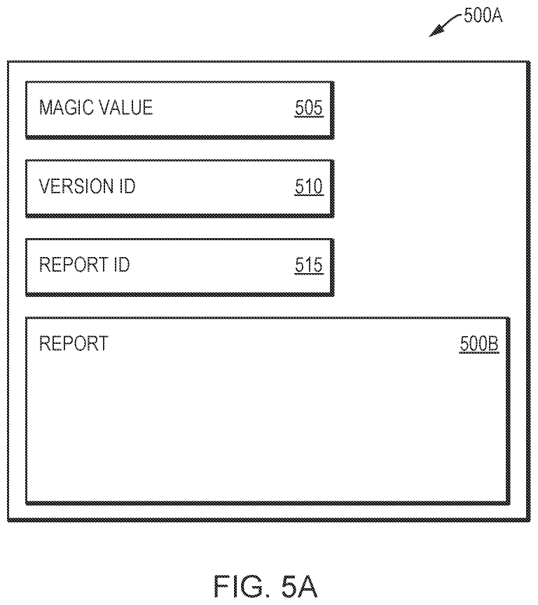

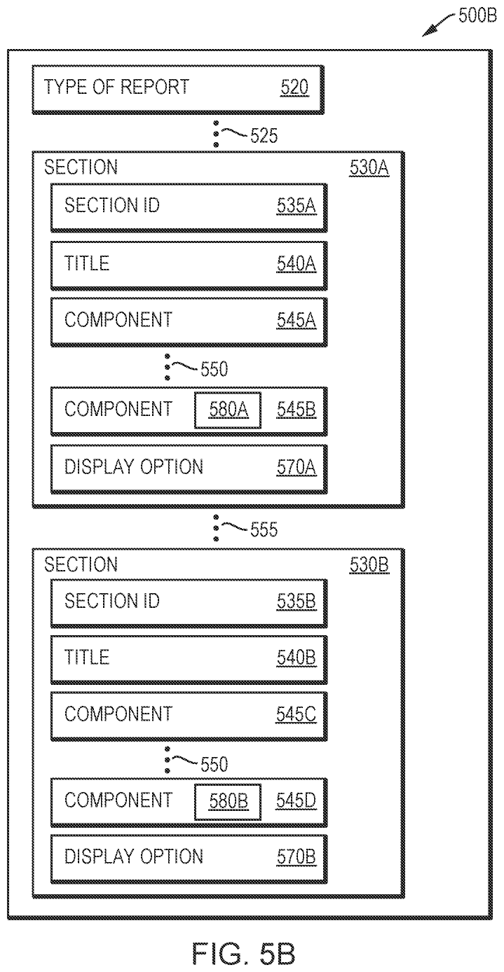

A report 500 is illustratively comprised of a report wrapper data structure 500A that encapsulates a report data structure 500B. FIG. 5A is an exemplary report wrapper data structure 500A in accordance with an illustrative embodiment of the present invention. Illustratively, the report wrapper data structure 500A includes a magic value field 505, a version identifier field 510, a report identifier field 515, and a report data structure 500B. The magic value field 505 illustratively contains a magic value that identifies this data structure as a report or a live report. This may comprise, e.g., a predefined bit pattern identifying the data structure as a report or a live report.

The version ID field 510 identifies which version of the report data structure is utilized for this report. As new features are added to the report data structure, the version ID may be changed so that a report renderer can identify if it is capable of supporting all of the features included in the report. A report renderer may also utilize the version ID to determine how to interpret the report data structure 500B as changes to that layout may occur between versions. For example, a new component may be added to the universe of components that can be rendered within a report in Version X. If a report renderer is capable of supporting up to Version Y, and Y<X, the report renderer may not be able to render all of the components within the report. In such cases, the report renderer may present an error message, cause an automated update to occur, etc. as will be appreciated by those skilled in the art.

The report ID field 515 is utilized to provide an identifier of the report contained within the report data structure 500B. Illustratively, the report generator provides the report ID when the report is generated.

It should be noted that while the report wrapper data structure 500A is shown having particular fields and arrangement, in alternative embodiments of the present invention, the report wrapper data structure 500A may comprise a differing layout. As such, the description contained herein should be taken as exemplary only.

FIG. 5B is an exemplary report data structure 500B in accordance with an illustrative embodiment of the present invention. The report data structure illustratively comprises of a type field 520 and one or more section fields 530A,B. Additional fields 525 may be included before the first section field 530A. Illustratively, the type field 520 identifies a type of report contained herein. This type may be used by the report renderer to make choices as to how to render certain components. For example, if the report type is a financial report, negative numbers may be displayed in parentheses, e.g., ($1,050.45), as is common with financial reports. In an embodiment, the type field 520 may indicate if the report is to be rendered as live or not.

Each section field 530 includes a set of entries including, for example, a section identifier field 535, a title field 540, one or more component fields 545, optionally one or more section display option fields 570, and on/or more component display option fields 580. The section identifier field 535 identifies what type of section is associated with the field. In accordance with illustrative embodiments of the present invention, a report generator/renderer may include a plurality of predefined section types, e.g., a Balance Sheet, a Profit and Loss, a Spending Analysis, etc. in the case of a financial report.

A title field 540 includes an exemplary text string that may be used as the title of the section when it is rendered. In accordance with illustrative embodiments of the present invention, certain sections may utilize predefined titles; however, in alternative embodiments, a user may modify the title at the time of report generation.

The component fields 545 identify components that are associated with the section. The components may be selected from a list of predefined components supported by the report generator/renderer. Exemplary components may be differing types of graphs, e.g., line, bar, etc., types of charts, e.g., pie, etc. As will be appreciated by those skilled in the art, the components that may be utilized may vary depending on a type of report and the field in which the report is generated.

The section display options field 570 may identify one or more different ways in which data can be highlighted, accentuated, or prioritized in a report section. For example, a display option may be a sparkline visual for each row or column in a profit and loss statement, e.g., a particular type of predefined report section.

The component display options field 580 may identify one or more different ways in which data can be highlighted, accentuated, or prioritized in a component. For example, a display option may be a width a component is displayed on a display screen. The width may be automatically selected based on the type of electronic device on which the rendering is performed. Alternatively, the width may be selected by a user.

Whether automatically selected or user selected, the width may be saved as a display option for a component in component display options field 580 and/or for a section in section display options field 570. In an embodiment, the selected widths may include, but are not limited to, (1) a full width that is a width of a standard printed page that includes the full component details, (2) a half width that only includes summarized/simplified data (e.g., parent categories of a profit and loss statement) that may be optimal for a mobile device display screen, or (3) a tile width, e.g., ⅓ or ¼ page width, that only includes a summary metric (e.g., net income for a profit and loss statement) that may be optimal for a tappable or smart watch style device. In an embodiment, a component may be moved on a display screen by a user utilizing one or more input commands (e.g., touch-screen drag and drop).

Another illustrative display option may be referred to as a time period display option that can be applicable to sections and/or components as described herein. As an example, consider a report, which is generated according to the one or more embodiments as described herein, relates to the time frame of November 2023. To that end, one or more components in a particular section of the example report may be rendered, as described herein, to display data related to November 2023. According to the one or more embodiments as described herein, a different component in the particular section may be rendered, as described herein, to display data related to November 2022. As a result, the single particular report section that includes adjacent components allows a user to easily visually compare the data from the same month but different years. Even more, an additional component in the particular section may be rendered, as described herein, to display data from January through November 2023 (e.g., a year-to-date component). As a result, the single particular report section includes a plurality of adjacent components that allows a user to easily visually identify trends over time. In an embodiment, the time period display option may be user selectable and may override, for example, a default setting in a report.

Based on the position of a component in relation to a different component, the one or more embodiments as described herein may automatically resize a width of one or more components such that the components are optimally displayed for viewing on a display screen of a particular type of computing device (e.g., computer, tablet, smart watch, etc.). That is, the hierarchical structure may be utilized to initially display the data using what is determined to be the optimal sections and components and/or the position of the sections and/or components on the display. A user may then, for example, modify the position of the sections and/or components using one or more input commands such as, but not limited to, drag-and-drop input commands using a pointing device or using a touch-screen.

In accordance with an illustrative embodiment of the present invention, one section may comprise a component that lists all transactions included in the report. In accordance with alternative embodiments of the present invention, this section may or may not be rendered when the report is displayed. However, by including it within the report data structure, the transaction data is available for use. One exemplary use would be to enable a report renderer to display individual transactions if, for example, a user clicked on a slice of a pie chart. That is, if a user clicked on a slice of a pie chart of a report rendered in a web browser, the report renderer could display all the transactions that are associated with that slice. By including the list of transactions, a report renderer may provide a more interactive experience with a report as compared to conventional static report displays.

Illustratively, certain components may be interactive components that comprise additional data, e.g., underlying transaction or other entry data, that may not be initially rendered. In the example of a pie chart, the individual transactions/entries may not be displayed, but only various categories. However, if a user selects a part of the component in the report renderer, the renderer may further render the component to display the additional data, e.g., a list of transactions that had been aggregated into a slice of a pie chart.

While an exemplary data structure 500 A, B is shown and described to store a report, it should be noted that in accordance with alternative embodiments of the present invention, differing data structures may be utilized. In one exemplary embodiment, the report data structure and wrapper are implemented in Protocol Buffers or other techniques for serializing structured data. An exemplary definition is shown below:

| ReportDefinition { | |
|---|---|
| string report_id | |
| string version_id | |
| ReportKind kind | |
| repeated Section sections | |
| enum ReportKind { | |
| WeeklyExpensesReport | |
| MonthlyExpensesReport | |
| CashflowReport | |
| ProfitLossReport | |
| <etc> | |
| } | |
| } | |
| Section { | |
| string section_id | |
| string title | |
| repeated Component components | |
| } | |
| Component { | |
| string component_id | |
| string title | |
| oneof Kind { | |
| NestedComponent | nested_component |
| TransactionList | transactions_list |
| VendorList | vendors_list |
| SummariesByVendors | vendors_bar_chart |
| SummariesByVendors | vendors_scatter_plot |

```
    <etc, all supported components>
  }
}
// Special Component type to encapsulate other components,
// for example, to group 2 vendor components (chart & list)
and present them in the same row.
NestedComponent {
  repeated Component components
}
```

By creating a hierarchical structure that contains the underlying data, a report renderer may render the report and enable the report to be interactive, depending on the limitations of the renderer. Specifically, and because the report 500 is a hierarchical data structure that is platform independent, the report 500 may be utilized by report renderers of different types of electronic device (i.e., different platforms) to display information associated with the report 500 that may be modified/adjustment such that the same information can be displayed differently on different electronic devices have different display characteristics. Moreover, because the hierarchical structure can define the manner in which particular data is displayed in each report section with one or more different components and/or display options, the hierarchical structure may serve as a template that can be saved and reused. For example, a particular hierarchical structure may render a particular type of data in a desirable way. That particular hierarchical structure can be used to, for example, render the same type of data in the same manner each month or some other predefined time frame such that rendering of the particular data is consistent over time. Because the data is rendered consistently over time by using the hierarchical structure that acts as a template, users can more easily identify patterns, issues, and/or positive aspects corresponding to the data that is consistently rendered based on the hierarchical structure.

In addition, only a single report 500 (e.g., a hierarchical data structure), according to the one or more embodiments described herein, needs to be generated and stored such that information associated with the report can be rendered and display on a plurality of different types of devices that may, for example, include different display characteristics. That is, a different report for each different type of electronic device that may have different display characteristics need not be generated and stored according to the one or more embodiments described herein. Accordingly, the one or mor embodiments described herein provide an improvement to the computer itself by preserving storage resources of the computer (e.g., preserving storage resources of server 200 that includes report generator 250 that generates report 500).

### III. Exemplary Rendered Report

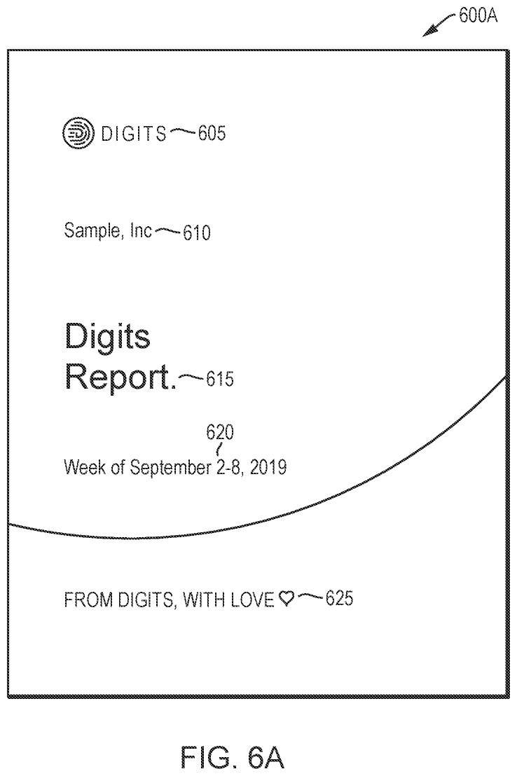

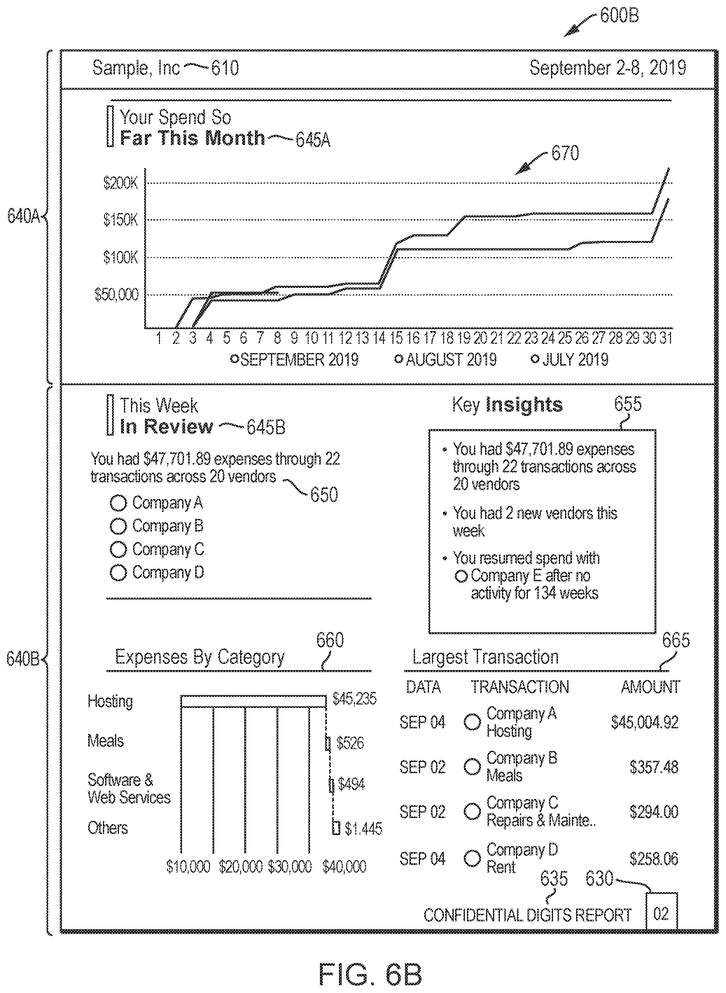

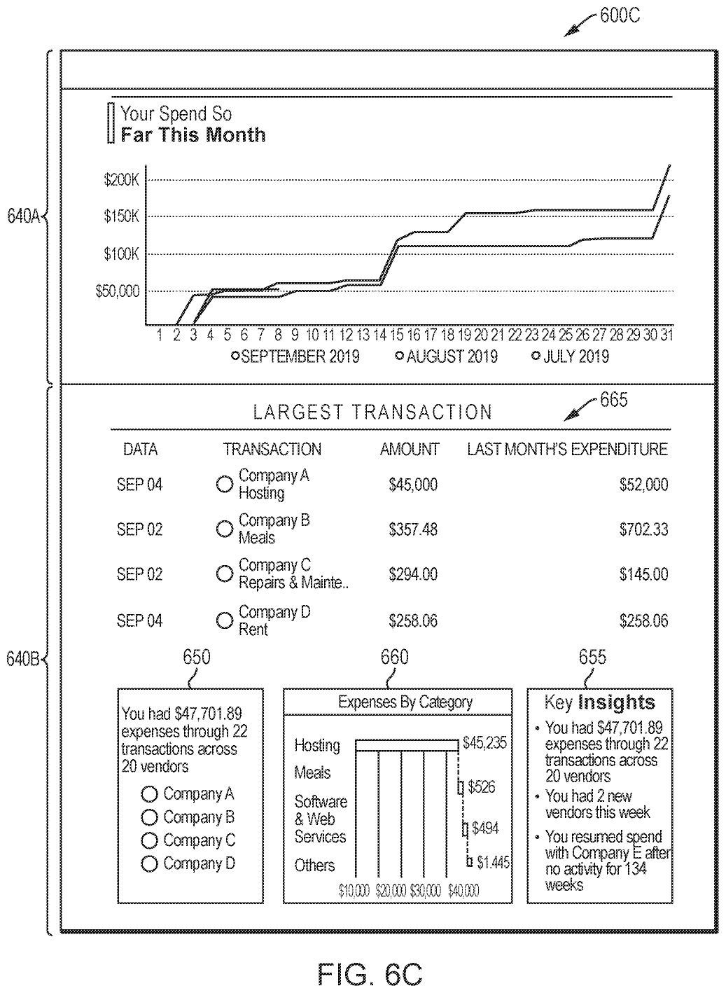

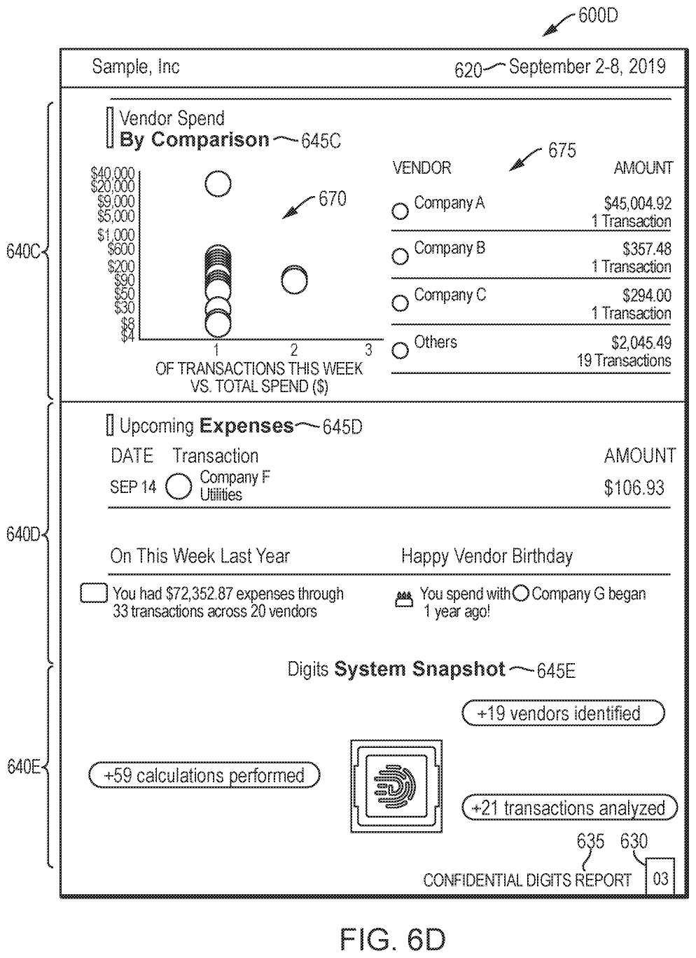

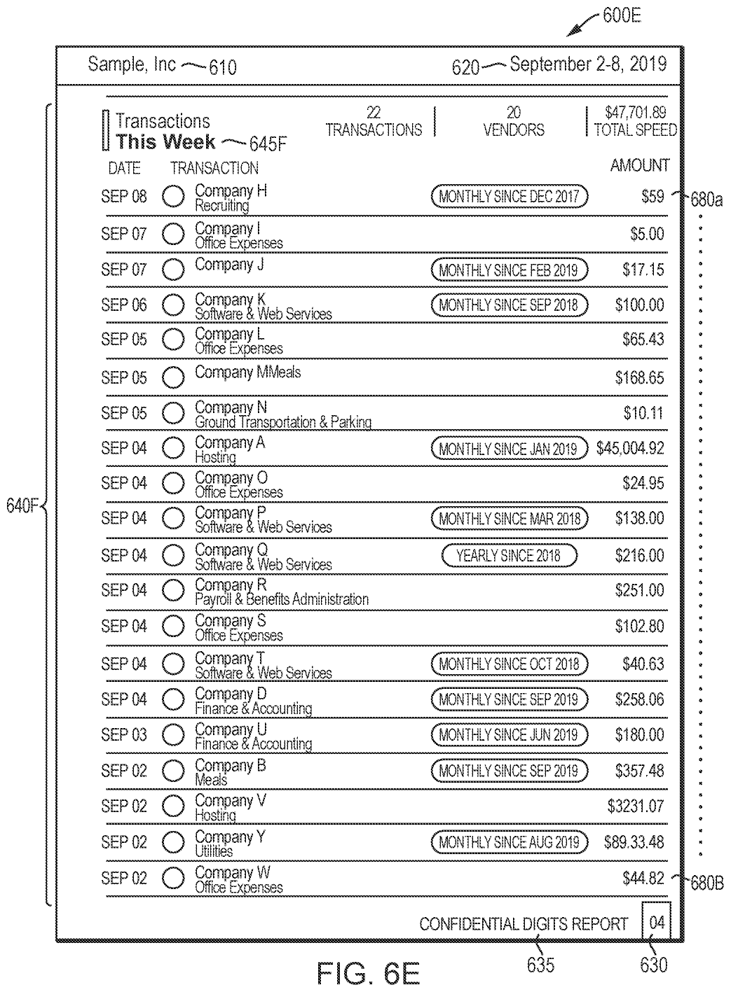

FIGS. 6A-6E are exemplary images of pages of a report generated and rendered in accordance with illustrative embodiments of the present invention. It should be noted that the particular layout and structure of report pages should be taken as exemplary only and are designed to show a general layout of sections and components in accordance with an illustrative embodiment of the present invention. The exemplary report displayed in FIGS. 6A-6D is a weekly spending report for a business. In accordance with alternative embodiments of the present invention, differing reports will have differing sections and/or components. Therefore, the report illustrated in FIGS. 6A-6D should be taken as exemplary only.

FIG. 6A is an image of a first page 600A of an exemplary report in accordance with an illustrative embodiment of the present invention. The first page 600A may be a title page that includes one or more objects including, e.g., a system logo 605, a company identifier 610, a report title 615, a time period 620, and/or optional text/and or graphics 625. The system logo 605 may be a predefined logo and/or text that identifies the software system that generated the report, such as application 215. This may be configurable within the software system. In alternative embodiments, no system logo 605 is displayed. In an embodiment, the first page 600A, which may be referred to as a cover page, may be customizable and may be rendered/generated based on the exemplary report data structures as described herein (e.g., exemplary report data structure 500B of FIG. 5B).

As an example, the company for which the report is generated may prefer that the first page 600A have a certain look, feel, and/or include particular information. In an embodiment, a user affiliated with the company may use one or more input devices to indicate what features should be included on the first page. For example, the user may upload a graphic of the company logo that is preferred to be included on the first page 600A. In response to the uploading, the one or more embodiments as described herein may accept the graphic and store the corresponding graphic (or a link to the graphic) in the appropriate field (e.g., section display options field 570 and/or component display options field 580 of the exemplary report data structure 500B for page 600A). In response, the one or more embodiments as described herein may access the graphic from the report data structure and populate the first page 600A with the image that is stored in the exemplary report data structure.

As an additional example, the user may utilize an input device to provide a title for the report. In response to the user provided title, the one or more embodiments as described herein may accept the title and store the title in the appropriate field e.g., section display options field 570 and/or component display options field 580 of the exemplary report data structure 500B). In response, the one or more embodiments as described herein may access the graphic from the report data structure and populate the first page 600A with the title that is stored in the exemplary report data structure.

Therefore, and according to the one or more embodiments as described herein, the first page 600A (e.g., cover/title page) may be customizable in any of a variety of different ways based on, for example, user preferences and the data stored in the report data structure as described herein.

The company identifier 610 provides an illustrative text field that is used to identify the company, person, or other entity with which the report is associated. This may be the name of a corporate entity in the example of a financial report, with the name of a particular plant in the example of a monitoring/control report, etc. The report title identifies the report. The time period 620 identifies the time period associated with the report. This may be configurable by the report generator and based on the type of report being generated. For example, “Dec. 31, 2020”, “Week of September 2-8, 2019”, “Jul. 3, 2020”, etc. The format may vary depending on application needs.

The optional text field 625 may be used to display a logo, slogan, and/or other information, such as a distribution restriction, e.g., “CONFIDENTIAL—Accounting Department Only”, etc.

FIG. 6B is an image of a second page 600B of an exemplary report in accordance with an illustrative embodiment of the present inventions. The page 600B illustratively includes a header that comprises the company identifier 610 and time period 620. A footer illustratively comprises a page number 630 and customizable text 635.

Exemplary page 600B includes two sections 640A,B of the report. Exemplary section 640A includes a section title 645A and a single component 670. Exemplary section 640B also includes section title 645B as well as a number of components 650, 655, 660, 665. As can be seen, section 640A is a single component section, while section 640B is a multi-component section. According to the one or more embodiments as described herein, section 640A may span the entire width of second page 600B because single component 670 of section 640A is a linear graph. As such, the one or more embodiments as described herein may determine that it is optimal for sections 640A and 640B to be on top of each other on second page 600B instead of next to each other on second page 600B. If, for example, sections 640A and 640B are positioned next to each other on second page 600B, the details of single component 670A may not be visually discernable such that a user can obtain the details from the linear graph. As such, the one or more embodiments as described herein may determine that the optimal display is for sections 640A and 640B to be on top of each other.

According to the one or more embodiments as described herein, a user may manipulate the position of the components within a report section such that the one or more embodiments as described herein can automatically modify the width of the re-positioned components for optimal display/rendering.

For example, let it be assumed that a user uses an input device to manipulate the page 600B of FIG. 6B to modify the arrangement of the components in section 640B. Specifically, and for this example, let it be assumed that the user wants to more closely analyze component 665 of section 640B to obtain more details regarding the largest transactions. The user may drag and drop component 665 in a middle upper location, e.g., between components 645B and 655, of section 640B. In response, the one or more embodiments as described herein may automatically modify the width of the components to accommodate the manipulation by the user as depicted in FIG. 6C.

FIG. 6C is an image of a third page 600E of an exemplary report in accordance with an illustrative embodiment of the present invention. Third page 600E includes sections 640A and 640B that are included in FIG. 6B. However, for the example of FIG. 6C, the components 650, 655, 660, and 655 of section 640B are rearranged differently when compared to their positioning in FIG. 6B based on the user manipulation as described above.

Because of the user manipulation, the one or more embodiments as described herein may automatically adjust the width of each component for optimal display in section 640B that is rendered on a particular computing device (e.g., mobile phone, smart watch, desktop computer, etc.).

As depicted in FIG. 6C, the user manipulation to place component 665 by itself in the top portion of section 640 causes the components 650, 660, and 655 to be modified in size (e.g., width) so that the visual representation of component 665 can be enhanced for the user. Specifically, and as depicted in FIG. 6C, component 665 now, when compared to FIG. 6B, spans the entire width of section 640B. As such, more details, such as last month's expenditure, and a reformatted component 665 with larger text can be rendered based on the overall width that is provided for component 665. That is, because the component 665 increases in width due to the user manipulation, the one or more embodiments as described herein can automatically modify the component and its data to conform to the new width. Advantageously, and based on the user manipulation, component 665 can span the width of the third page 600E such that the user is provided with the additional information of last month's expenditure that the user can compare to the current month's expenditure.

As a result, other components 650, 660, and 655 can be automatically resized (e.g., width) to fit within the remaining portion of section 640B. Specifically, and as depicted in FIG. 6C, components 650, 660, and 655 are each narrower in width to fit within the bottom portion of section 640B. Therefore, a user may reorder the one or more components that are provided within a section based on the user's preferences. In response, the one or more embodiments as described herein can adjust the size (e.g., width or height) of the one or more components to optimally render, i.e., display, the one or more components in the section such that the data is best suited for viewing by the user.

FIG. 6D is an image of a fourth page 600C of an exemplary report in accordance with an illustrative embodiment of the present invention. Like page 600B, this page includes a multi-component section 640C, as well as single component sections 640D,E.

FIG. 6E is an image of a fifth page 600D of an exemplary report in accordance with an illustrative embodiment of a present invention. Exemplary page 600D includes a single section 640F that is entitled 645F as “Transactions This Week.” The various components 680A, B of the section are individual entries for each transaction that is included in the report.

### IV. Exemplary Generation of A Self-Contained Report Data Structure

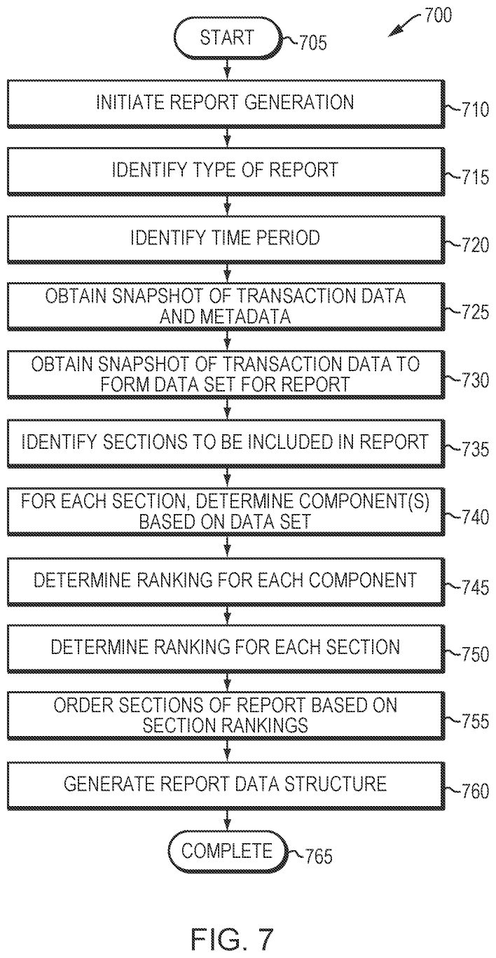

FIG. 7 is a flowchart detailing the steps of an exemplary procedure 700 for automatically generating a report in accordance with an illustrative embodiment of the present invention. While the present disclosure is written in terms of preparing a financial report (e.g., static or live reports), it should be noted that the principles of the present invention may be utilized to generate non-financial reports. Therefore, the description of data entries as transactions and financial terminology should be taken as exemplary only. The procedure 700 begins in step 705 and continues to step 710 where the report generation is initiated. This may occur due to a predefined schedule, user activation, in response to an application detecting predefined criteria being met, etc.

In step 715, the report generator identifies the type of report to be generated. This detection may be the result of user action or as part of the predefined schedule. Illustratively, the type of report is used to determine the types of sections to be included in the report. For example, a weekly spending report may include those sections described above in relation to FIGS. 6A-D, while a revenue report will have differing sections contained therein. Then, in step 720, the time period to be covered by the report is identified. Like the determination of the type of report, this may occur due to the predefined schedule or by user action.

In step 725, the system obtains a snapshot of the transaction data and metadata. Illustratively, this occurs by the report generator obtaining a snapshot of the data, such as transaction data 245, and associated metadata associated with the type of report to be generated. From the snapshot acquired in step 725, a snapshot of the transaction data needed for the report is obtained in step 730 by generating a data set of the applicable data, e.g., transactions 245 that are application to the type of report and time period. While steps 725 and 730 are shown as two separate steps, in alternative embodiments, a single data collection may occur that identifies all data that is application to the type of report and time period. Therefore, the description of two steps should be taken as exemplary only. At the conclusion of step 730, the report generator has the complete set of data that is to be used in generating the report. That data may illustratively be included in a section of the report listing all transactions.

The report generator then identifies what sections are to be included in the report in step 735. This is illustratively based on the type of report as well as the transaction data. The system illustratively includes a set of predefined sections for types of reports. In the example report shown in FIGS. 6A-E for a weekly spending report, exemplary sections may be the amount spend so far in a month, the week in review, a comparison of vendor spend, upcoming expenses, etc. For other types of reports, differing sections may be utilized. Exemplary pseudocode for implementing step 735 is provided:

```
let sections = switch (report_type) {
  case ″P&L REPORT″:
    return array(INCOME_EXPENSE_CATEGORY_LIST)
  case ″BALANCE SHEET REPORT″:
    return array(ASSET_LIABILITY_CATEGORY_LIST)
  case ″MONTHLY EXPENSE REPORT″:
    return array ( SPEND_OVERVIEW_GRAPH,
          TOP_CATEGORIES,
          TOP_VENDORS,
          NEW_VENDORS,
          ACTIVE_SUBSCRIPTIONS)
  . . .
  <more report types>
  . . .
  case ″CUSTOM REPORT″:
    return GET_USER_SPECIFIED_REPORT_SECTIONS( )
}
```

As will be appreciated by those skilled in the art, a system may include a number of predefined types of reports. In alternative embodiments, a system may enable a user to generate and store a user specific, i.e., custom, report, that is encoded into the report generator/renderer's master list.

For each section to be included, the report generator identifies what component(s) should be included and the display options to be used based on the data in the in the data set in step 740. This may be accomplished by analyzing the data to determine what component may be utilized to display the data and what display options may be best to highlight, enhance, and/or accentuate the data. For example, if a category has a negative value, e.g., a refund, then a pie chart is not appropriate for displaying that data. Similarly, if the component is to display a profit and loss report, then a sparkline visual may be used for each row in the component. Exemplary pseudocode for step 740 is shown below:

```
let components = switch (section) {
  case ″TOP_CATEGORIES″:
    return array ( CATEGORY_PIE_CHART,
          CATEGORY_WATERFALL_GRAPH,
          CATEGORY_TABLE)
  case ″ACTIVE_SUBSCRIPTIONS″:
    return array ( SUBSCRIPTIONS OVER_TIME_BAR_CHART,
          SUBSCRIPTIONS_BY_CATEGORY_PIE_CHART,
          SUBSCRIPTIONS_BY_CATEGORY_TABLE,
          LARGEST_SUBSCRIPTIONS_TABLE,
          DUPLICATE_SUBSCRIPTIONS_TABLE)
  . . .
  <more section types>
  ...
}
```

In step 745, each component is ranked. Exemplary pseudocode for ranking components is below:

```
const BAD = 50
const GOOD = 75
const GREAT = 100
let component_score = switch (component) {
  case ″CATEGORY_PIE_CHART″:
    // if one of the categories has a negative total
amount
      return BAD
    // if there are less than 10 categories
      return GREAT
    // otherwise (pie charts work, but are hard to
read with lots of slices)
      return GOOD
  case ″LARGEST_SUBSCRIPTIONS_TABLE″:
    // if largest subscription < 49.00 (i.e. all
subscriptions are pretty cheap)
      return BAD
    // if there are more than 10 active subscriptions
      return GREAT
    // otherwise (if there are very few active
subscriptions, we do not need a whole table dedicated to
just the big ones)
      return GOOD
  case ″DUPLICATE_SUBSCRIPTIONS_TABLE″:
    // if there are 1 or more duplicate subscriptions
(subscriptions with the same vendor)
      return GREAT
    // otherwise
      return BAD
  . . .
  <more component types>
  ...
}
```

As can be appreciated from the exemplary pseudocode, each component illustratively includes a specific ranking decision tree that takes into account the positive and negative attributes of that component type as compared to the data to be included in the component.

In step 750, each section is then ranked. Illustratively, each section is assigned the rank of the highest component score contained therein. In alternative embodiments, a section may be ranked by combining the rankings of the components contained therein. However, in alternative embodiments, differing ranking systems may be utilized. Therefore, the description of a particular ranking system should be taken as exemplary only.

The report generator, in step 755, then orders the sections based on the rankings calculated for each section. In an illustrative embodiment, the sections or ordered from highest to lowest ranked. However, in accordance with alternative embodiments of the present invention, differing methods may be utilized. For example, a user may provide configuration so that a particular section is always displayed in a particular location, e.g., first. This ordering based on ranking serves to highlight items that are deemed important to a user of the report. This is a noted advantage over conventional static reports that display portions in the same order, regardless of whether information has changed that should be highlighted to a user.

Exemplary pseudocode for implanting step 755 is provided:

```
let report_sections = SORT(sections, using: (left, right) {
  // if left. score > right.score
    return left
  // else if right.score > left.score
    return right
  // otherwise (the scores are equal)
    // if left.preference >= right.preference
      return left
    // otherwise
      return right
```

The report data structure 500 is then generated in step 760. The data structure is generated to produce the report as ordered sections and components. The data structure may be saved in persistent storage or fed into a report renderer for display to a user. Exemplary pseudocode is provided:

```
const MINIMUM_SCORE_THRESHOLD = 70
let report_data = array( )
for each section in report_sections {
  for each component in section.components {
      if component.score > MINIMUM_SCORE_THRESHOLD {
        report_data.append(component.data)
    }
  }
}
```

In an illustrative embodiment, any components that have a ranking above a predefined threshold are included in the report data structure. It should be noted that the predefined threshold may vary by, e.g., report type, section type, etc. Therefore, the description of a universal threshold value should be taken as exemplary only.

In an alternative embodiment of the present invention, the report data structure, which may be illustratively implemented as a serialized data structure, may be appended to a second data structure. This second data structure may comprise another, conventional, report type, such as a portable document format (PDF) file. In such alternative embodiments, a conventional report renderer, such as a PDF viewer, may render the report contained within the second data structure. If a report renderer is available that is compatible with the teachings of the present invention, then the more advanced report described herein may be rendered. It should be noted that while the term appended is used to describe the associating of the exemplary report data structure and the second data structure, in alternative embodiments, the reports may be associated in different ways, e.g., prepending, encapsulating in a larger data structure, etc. Therefore, the description of appending the two data structures should be viewed as illustrative only. The procedure ends in step 765.

### V. Exemplary Rendering of A Self-Contained Report Data Structure

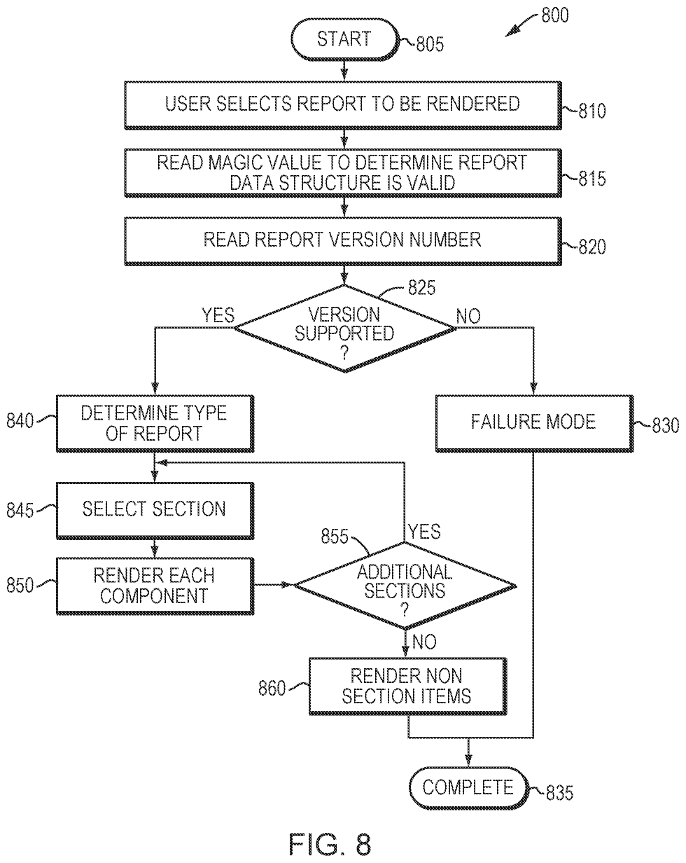

FIG. 8 is a flowchart detailing the steps of a procedure 800 for rendering a report in accordance with an illustrative embodiment of the present invention. The procedure 800 begins in step 805 and continues to step 810 where a user selects the report to be rendered.

In step 815, the report renderer reads the magic value of the report data structure 500 to determine that the data structure is a report. By examining the magic value, the report renderer then knows that the data that is being read is a report, thereby allowing it to interpret the contents contained therein.

The report version number is then read in step 820 and a determination is made in step 825 whether the report renderer supports the indicated version. As the report data structure is updated, additional components or features may be added. The report renderer will need to be upgraded so that it is capable of understanding newer versions of the report data structure in order to interpret the report data structure to render the data contained therein.

If the version is not supported, the procedure branches to step 830 where a failure mode is entered. Various options exist for the failure mode. In one exemplary embodiment, the report renderer may present an option to download or otherwise install an updated version of the report renderer that is capable of supporting this version of the report data structure. In alternative embodiments, the report renderer may provide a link to another report renderer to render the report. For example, a report renderer integrated into an application may provide a link to a report renderer operating on a website that may be able to interpret the report data structure and render the report.

If the report version is supported, the procedure branches to step 840 where the type of report is identified. By identifying the type of report, the report renderer knows what types of sections may be included in the report.

The first section is selected in step 845 and each component and/or display options for that section is rendered in step 850. This may be accomplished by, for example, reading the report data structure to identify the first section of the report as well as the associated components and/or display options. The data for each component is obtained from the report data structure list for entries. Illustratively, the report renderer may adjust the display of the report based on the display characteristics of the device on which it is running. For example, two components may be displayed side by side when rendered on a desktop computer but displayed one after another (e.g., one on top of another) when rendered on a smart phone or other mobile device with a limited screen size.

Because the report render may optimally modify/adjust the display of the components of the display based on the display characteristics of the electronic device such that different display modifications/adjustments may be performed for different electronic devices (e.g., desktop computers, laptop computers, mobile devices), the one or more embodiments described herein are necessarily rooted in computer technology. By storing the report in a platform independent data structure, a report renderer may display the report in a manner most suitable to the device on which it is running, e.g., desktop computer, tablet, smart phone, etc. As such, the one or more embodiments described herein provide an improvement in the existing field of electronic display across different types of devices.

After completing each component of the section, a determination is made in step 855 whether there are additional sections to be rendered. If so, the procedure branches to step 845 and selects the next section.

If there are no additional sections to be rendered, the procedure then continues to step 860 to render non-section items. These non-section items may include, e.g., items of an exemplary first page 600A of a report, such as a system logo, etc.

The procedure then completes in step 835. Once completed, the report has been rendered into the appropriate display format. As noted above, certain components may be interactive. For such interactive components, the report renderer may detect user actions such as hovering over a value or portion of a component, clicking on part of the component, highlighting part of a component, etc. In response, the report renderer may utilize the full set of data entries contained within the report data structure to show data in a differing granularity of format. One example would be if a user clicks on a slice of a pie chart, the report renderer may pop up a small window to display all of the individual entries that were aggregated into that slice. The user can then, for example, click on a particular individual entry to learn more about that particular individual entry. Therefore, and according to the one or more embodiments as described herein, the user can drill-down to obtain more details regarding information in a report. Moreover, the components of a report section can be automatically adjusted in size (e.g., width and/or length) based on user manipulation as described above with relation to FIG. 6C.

Additionally, the report generated according to the one or more embodiments as described herein may transition between a live report and a static report. For example, a user may provide an input command, e.g., touch-screen and/or keyboard, to select that can be used to transition between a live report and a static report. As an example, let it be assumed that a live report is generated as described above based on the flow diagrams of FIGS. 7 and 8. Because the report is live, the data within the report, e.g., within the sections of the report, can be constantly updated over time with the most up-to-date data. For example, the data within the report may be updated every second or some other time interval.

In this example, let it be assumed that the live report is generated and modified iteratively during a time frame by different team members that are internal to an entity. When the live report is determined to be in a state and form that is desirable to be shared with external sources (e.g., shareholders, customers, etc.), a user of the entity may provide user input to transform the live report (i.e., dashboard) to a static report. For example, the user may provide user input by selecting a graphical button within the application that displays the report.

Additionally, the user may provide, via user input, a date range indicating the time frame for which the data should be obtained to populate the report. Based on the user input, the one or more embodiments as described herein can generate a static report that only includes the data from the time range. In an embodiment, the date range may be based on a single date or any two dates provided by the user and does not need to be confined to a predefined time range such as a month or a quarter. This allows an entity that generated the report to determine which data is to be shared with the external source, wherein that data is unmodifiable in the report. As a result, the entity may use a live report (dashboard) internally, i.e., internal to an entity, and then share a corresponding to static report externally.

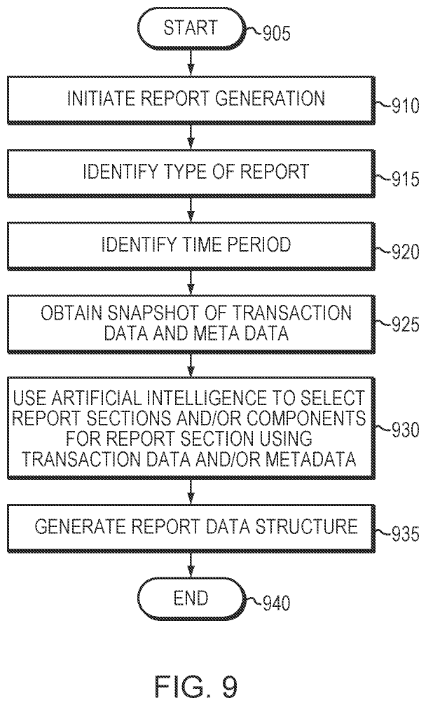

FIG. 9 is a flowchart detailing the steps of a procedure for automatically generating a report using artificial intelligence in accordance with an illustrative embodiment of the present invention. The procedure 900 starts at step 905. The procedure then continues to steps 910, 915, 920, and 925. Steps 910-925 may be performed in a similar manner as described above in relation to steps 710-730 of FIG. 7.

The procedure continues from step 925 to step 930. At step 930, the report generator 250 utilizes artificial intelligence (AI) to select one or more report sections and/or one or more components for the report sections using the transaction data and/or the metadata. In an embodiment, the report generator 250 may utilize generative AI to select the report sections and/or the components. Specifically, the report generator 250 may use AI predictive models that are provided particular input to generate as output one or more report sections and/or components for the transaction data and metadata identified in step 925.

For example, let it be assumed that the report generator 250 is initiated by a user at the end of a month. Further, let it be assumed that in the previous 3 months the report generator 250 has generated 3 different reports for the user at the end of those months, wherein each of the 3 different reports may include different sections and different components. The report generator 250 may utilize one or more AI predictive models to predict/identify which sections and components from the 3 different previous reports should be utilized for the current report being generated. In an embodiment, the one or more AI predictive models may be generated based on supervised learning that uses different types of input data (i.e., input training data) that are related to report generation as described herein to generate the AI predictive models that output different sections and/or components i.e., output training data) based on the input data.

In an embodiment, the transaction data, metadata, time of the month when the report is to be generated, etc. may be provided as input to the one or more AI predictive models. The one or more AI predictive models may process the provided input data to identify, as output, one or more report sections and/or components that are best suited for displaying the transaction data. As an example, let it be assumed that the following is provide as input to the AI predictive models. The AI predictive models may process the input data to determine that are best suited to display the transaction data for the report.

The procedure may continue from step 930 to step 935 and the report data structure may be generated in a similar manner as described above in relation to step 760. Specifically, the report data structure may be generated based on the execution of the artificial intelligence as described above in relation to step 930. The procedure then ends at step 940.

It is expressly contemplated that the report data structure as generated in relation to FIG. 9 may be rendered, i.e., displayed, in the manner described above in relation to FIG. 8.

In a further embodiment, the report generator 250 may utilize AI to suggest report sections and/or components to a user based on the user's participation in a chat session with a chatbot or other user. For example, let it be assumed that Jane Doe is interested in generating a report according to the one or more embodiments as described herein. For this example, let it be assumed that Jane Doe accesses a particular Uniform Resource Locator (URL) using client device 300 or mobile device 400. In response to accessing the URL, Jane may initiate a chat session with a user working for an entity that manages/hosts the URL or a chatbot. For example, Jane may select a “chat” button on the URL to initiate a chat session that allows Jane to electronically communicate with the other user or the chatbot. Based on selection, a messaging window, which represents the chat session, may appear that allows Jane to communicate with the other user or chatbot using an input device, e.g., keyboard.

Continuing with the example, Jane may use the input device to communicate via the messaging window and provide input regarding the report to be generated. For example, the input may include, but is not limited to, type of transaction data, time of the month when the report is to be generated, etc. The report generator 250 may use the input provided via the messaging window and utilize the AI predictive models to identify one or more report sections and/or components that are best suited to display the transaction data. Based on the identification, the report generator 250 may output the identified report sections and/or components in the messaging window. Jane may then, for example, drag and drop the suggested report sections and/or components from the messaging window to an existing report to generate a report, in the manner described herein, that includes the suggested report sections and/or components identified using the AI predictive models.

According to the one or more embodiments as described herein, the report generator 250 may also operate in the background and proactively, and without user input, identify one or more report sections and/or components for a generated report that tailored for a user/entity. For example, the report generator 250 may access or obtain data corresponding to the user/entity, which, in this example is Jane Doe. For example, the data may include, but is not limited to, previous reports generated by Jane Doe, times at which Jane Doe generated the previous reports, the sections/components used in those reports, etc. The report generator 250 may provide the obtained data as input to one or more AI predictive models as described herein. The AI predictive models may process the obtained data to generate a report, with one or more particular sections and/or components, that are predictive of what Jane Doe would prefer. That is, the report may be generated using the AI predictive models such that the generated report is tailored for Jane Doe based on the analysis of the obtained data that is provided to the AI predictive models.

In an embodiment and based on the generation of the report using the AI predictive models, the report generator 250 may initiate a chat session with Jane Doe when, for example, Jane Doe has accessed a particular application or URL. The report generator 250 may generate a message for Jane Doe indicating that the report, generated using the AI predictive models, is available for Jane Doe. Therefore, and according to the one or more embodiments as described herein, the report generator 250 can proactively generate a report for Jane Doe and initiate communication with Jane Doe to provide the generated report to Jane Doe.

Jane may then be able to, for example, select a hyperlink from the chat window to access the generated report. Subsequently, Jane may manipulate the generated report in any of a variety of different ways as described herein. For example, Jane may change the layout of the sections and/or components that are originally rendered based on the utilization of the AI predictive models. As such, Jane is able to further customize the report generated using the AI predictive models.

According to the one or more embodiments as described herein, a report can be generated based on user manipulation of a user interface that, for example, may render an existing report. For example, the user may utilize different input commands (e.g., drag-and-drop) to modify an existing report until the user is satisfied with the final report. Data for the final report may be stored in the exemplary report data structure as described herein. Therefore, the final report that satisfies the users preferences can be used as a template such that future reports can be generated to have a similar look and feel for the user.

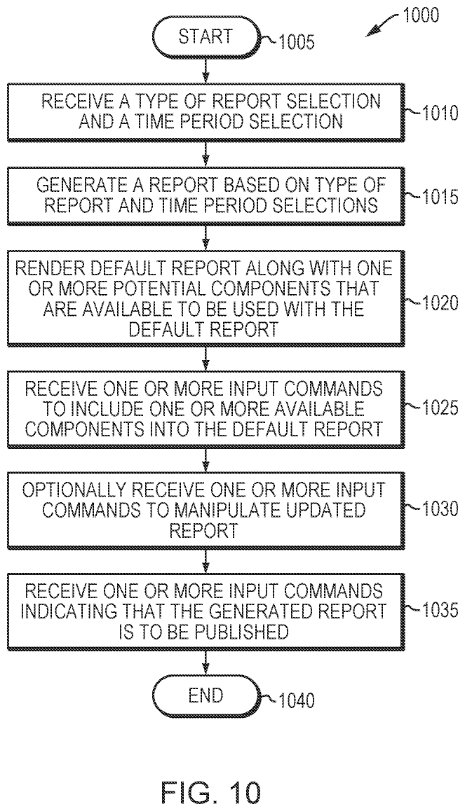

FIG. 10 is a flowchart detailing the steps of a procedure for automatically generating a report based on user manipulation within a user interface in accordance with an illustrative embodiment of the present invention. The procedure 1000 starts at step 1005 and continues to step 1010. In step 1010, the report generator 250 receives a type of report selection and a time period selection. For example, a user may utilize an input device of client device 300 to select a type of report and a time period that is of interest to the user. Alternatively, the selection of the type of report and the time period may be preconfigured (e.g., stored in memory or storage) and provided to the report generator 250.

The procedure continues from step 1010 to step 1015. At step 1015, the report generator 250 may generate a report in a manner described herein. For example, the report may be generated as described in relation to FIG. 7 and/or FIG. 9. In an embodiment, the report generated at step 1015 may be referred to as a “default report.” In an embodiment, the default report may be empty, e.g., without one or more sections that include components, or the default report may include one or more sections that include components.

The procedure continues from step 1015 to step 1020. At step 1020, the report generator 250 may render, e.g., display, the default report along with one or more potential components, which are part of one or more report sections, that are available to be used in the default report. For example, different types of reports and/or different time periods may have different components that are available for rendering. In an embodiment, the default report may be rendered in a predefined area of a palette on a display screen, while the available components may be rendered in a different predefined area of the palette on the display screen.

The procedure continues from step 1020 to step 1025. At step 1025, the report generator 250 may receive one or more input commands to include one or more available components into the default report. For example, the user operating client device 300 may use an input device to drag and drop particular available components, that are preferred by the user, into the default report. In response, the report generator 250 may modify the default report based on the selected available components and the location at where the drop action of the drag and drop operation is performed. For example, if the default report is an empty report, the report generator 250 may populate the default report with the selected available components at the location of the drop action. If, for example, the default report includes sections and/or components, the report generator 250 may remove the sections and/or components, located at the drop action and replace the to removed sections and/or components with the selected available components. Based on the addition of the selected components to the default report, an updated report may be generated according to the one or more embodiments as described herein.

The procedure continues from step 1025 to step 1030. At step 1030, the report generator 250 optionally receives one or more input commands to manipulate the updated report. For example, a user operating client device 300 may (1) rearrange the positions of components in a section, (2) rearrange the positions of the sections in a report, (3) select a component to identify its display options and modify the display options using input commands (e.g., the selection of the report, a section, and/or a component may result in a pop-up window that allow the user to view the current display options and/or select different display options), etc. Therefore, and according to the one or more embodiments as described herein, the generated report with the selected available components can be further modified in a plurality of different ways until the report meets the satisfaction of the user's preferences.

The procedure continues from step 1030 to step 1035. At step 1035, the report generator 250 receives one or more input commands indicating that the generated report is to be published. In an embodiment, a report that is published is indicative of the report meeting the user's satisfaction such that an exemplary report data structure as described herein and corresponding to the report should be saved. As such, the structure and configuration of the report can be used as a template for later use when generating future reports for the same user. The procedure then ends at step 1040.

Further, while this description has been written in terms of a financial software system, the principles of the present invention may be utilized with any form of software system that displays information in a graphical user interface. As such, the description of a financial system should be taken as exemplary only. While various components have been described as being implemented in hardware or software, it should be noted that it is expressly contemplated any of the functionality described herein may be implemented in hardware, software, firmware, or a combination thereof.

What is claimed is:

1. A computer implemented method comprising:
identifying a type of report for a report;
obtaining a set of data related to entries that are associated with at least the type of report;
generating input data utilizing at least one of the type of report and the set of data related to the entries;
providing the input data to one or more artificial intelligence predictive models that are pre-trained utilizing training input and output data;
processing, by the one or more artificial intelligence predictive models, the input data to generate output data that includes one or more report sections that are to be included in the report and one or more components that are to be included in at least one particular section of the report; and;
generating a serialized data structure that comprises a structured set of data configured to enable a report renderer to display, on a computer display screen, the one or more report sections each and the one or more components.

2. The computer implemented method of claim 1 wherein the one or more components are selected from a group consisting of a scatter plot, a line chart, a pie chart, a bar graph, and a table.

3. The computer implemented method of claim 1 further comprising:
providing, as a suggestion in a chat session window, the one or more report sections that are to be included in the report and the one or more components that are to be included in at least one particular section of the report.

4. The computer implemented method of claim 1 wherein output further includes one or more display options for the one or more components.

5. The computer implemented method of claim 4 wherein the display options include one or more of sparkline visual.

6. The computer implemented method of claim 1 further comprising ordering the one or more report sections by ranking each of the one or more report sections using each of the one or more particular components included in each of the one or more report sections.

7. The computer implemented method of claim 6 wherein ordering each of the one or more report sections further comprises assigning a rank value to each of the one or more report sections based on a selected component included in each of the one or more report sections.

8. The computer implemented method of claim 7 wherein the rank value is based on a comparison of the selected component with other components included in each of the one or more report sections.

9. The computer implemented method of claim 1 further comprising:
receiving user input to modify a position of a selected report section on the computer display screen; and
in response to receiving the user input, automatically adjusting a width of a different report section on the computer display screen.

10. A system comprising:
an application executing on a processor of a device, the application including a report generator, the report generator configured to:
identify a type of report for a report;
obtain a set of data related to entries that are associated with at least the type of report;
generate input data utilizing at least one of the type of report and the set of data related to the entries;
provide the input data to one or more artificial intelligence predictive models that are pre-trained utilizing training input and output data;
process, by the one or more artificial intelligence predictive models, the input data to generate output data that includes one or more report sections that are to be included in the report and one or more components that are to be included in at least one particular section of the report; and
generate a serialized data structure that comprises a structured set of data configured to enable a report renderer to display, on a computer display screen, the one or more report sections each and the one or more components.

11. The system of claim 10 wherein the report generator is further configured to provide, as a suggestion in a chat session window, the one or more report sections that are to be included in the report and the one or more components that are to be included in at least one particular section of the report.

12. The system of claim 10 wherein the device is a server.

13. The system of claim 10 wherein the one or more components are selected from a group consisting of a scatter plot, a line chart, a pie chart, a bar graph, and a table.

14. The system of claim 10 wherein the output further includes one or more display options for the one or more components.

15. The system of claim 10 wherein the set of data is stored within the serialized data structure.

16. The system of claim 10, wherein the report generator is further configured to order the one or more report sections by ranking each of the one or more report sections using each of the one or more particular components included in each of the one or more report sections.

17. The system of claim 16 wherein when ordering the one or more report sections, the report generator further configured assign a rank value to each of the one or more report sections based on a selected component included in each of the one or more report sections.

18. The system of claim 17 wherein the rank value is based on a comparison of the selected component with other components included in each of the one or more report sections.

19. The system of claim 10 wherein the report generator is further configured to:
receive user input to modify a position of a selected report section on the computer display screen; and
in response to receiving the user input, automatically adjust a width of a different report section on the computer display screen.

20. A non-transitory computer readable medium having software encoded thereon, the software when executed by one or more computing devices operable to:
identify a type of report for a report;
obtain a set of data related to entries that are associated with at least the type of report;
generate input data utilizing at least one of the type of report and the set of data related to the entries;
provide the input data to one or more artificial intelligence predictive models that are pre-trained utilizing training input and output data;
process, by the one or more artificial intelligence predictive models, the input data to generate output data that includes one or more report sections that are to be included in the report and one or more components that are to be included in at least one particular section of the report; and
generate a serialized data structure that comprises a structured set of data configured to enable a report renderer to display, on a computer display screen, the one or more report sections each and the one or more components.
